(19) United States
(12) Patent Application Publication
(10) Pub. No.: US 2025/0265306 A1
(43) Pub. Date: Aug. 21, 2025

(54) MASKED REFERENCE SOLUTIONS FOR MATHEMATICAL REASONING USING LANGUAGE MODELS

(71) Applicant: NVIDIA Corporation, Santa Clara, CA (US)

(72) Inventors: Shubham TOSHNIWAL, Jersey City, NJ (US); Ivan MOSHKOV, Yerevan (AM); Igor GITMAN, North Bend, WA (US)

(21) Appl. No.: 18/893,574

(22) Filed: Sep. 23, 2024

Related U.S. Application Data
(60) Provisional application No. 63/553,765, filed on Feb. 15, 2024.

(51) Int. Cl. G06F 17/11

(52) U.S. Cl. CPC G06F 17/11

(57) ABSTRACT

In various examples, a technique for performing a mathematical reasoning task includes inputting a first prompt that includes (i) a set of example mathematical problems, (ii) example masked solutions to the example mathematical problems, and (iii) a mathematical problem into a first machine learning model, wherein each masked solution includes a set of symbols as substitutes for a set of numbers in a ground-truth solution for a corresponding example mathematical problem. The technique also includes generating, via execution of the first machine learning model based on the first prompt, a set of candidate masked solutions to the mathematical problem. The technique further includes inputting a second prompt that includes (i) the mathematical problem and (ii) at least one masked solution into a second machine learning model and generating, via execution of the second machine learning model based on the second prompt, a solution to the mathematical problem.

### CROSS-REFERENCE TO RELATED APPLICATIONS

This application claims the benefit of U.S. Provisional Application No. 63/553,765, filed on Feb. 15, 2024, which is hereby incorporated by reference in its entirety.

### TECHNICAL FIELD

Embodiments of the present disclosure relate generally to natural language processing and machine learning and, more specifically, to techniques for generating masked reference solutions for mathematical reasoning using language models.

### BACKGROUND

Language models (LMs)—such as large language models (LLMs), vision language models (VLMs), multi-modal language models, etc.—include neural networks and/or other types of machine learning models that are capable of general-purpose language, vision, audio, and/or other modality understanding and generation. LMs are typically pre-trained on vast datasets of text and/or other types of content and include large numbers of parameters that allow the LMs to learn complex patterns in the content. After pre-training of an LM is complete, the LM is capable of using the same types of content to perform a wide range of tasks. The performance of a given LM on these tasks can then be evaluated and/or tracked to assess the strengths and weaknesses of the LM, compare the capabilities of different LMs, evaluate the effectiveness of datasets and/or techniques used to train and/or prompt the LMs, and/or incorporate the LM in applications and/or environments in which these tasks are performed.

One type of task that can be performed by a LM involves mathematical reasoning, in which the LM generates a solution that includes a series of steps for solving a mathematical problem and an answer to the mathematical problem that is determined by performing the series of steps. For example, an LM may be prompted with a text-based instruction for performing a mathematical reasoning task, a set of representative mathematical problems paired with the respective solutions in text and/or code format, and a question that includes a mathematical problem to be solved. Given this prompt, the LM may generate output that includes a candidate solution to the question, where the candidate solution adheres to the same format as that of the solutions to the representative mathematical problems.

However, pre-trained general-purpose LMs tend to exhibit limited mathematical reasoning abilities under conventional training and prompting approaches. For example, an LM that is prompted to solve a complex mathematical problem without additional context may fail to generate a correct solution or any solution to the complex mathematical problem. In another example, a prompt inputted into an LM may include a mathematical problem, a ground-truth text-based solution to the mathematical problem, and an instruction to generate a new code-based solution to the mathematical problem. In response to this prompt, the LM may generate a “shortcut” code-based solution that copies and returns the final answer to the mathematical problem from the text-based solution instead of producing code that can be used to correctly compute the final answer using mathematical principles and information from the mathematical problem.

As the foregoing illustrates, what is needed in the art are more effective techniques for improving mathematical reasoning abilities in LMs and/or other types of machine learning models.

### BRIEF DESCRIPTION OF DRAWINGS

FIG. 1 illustrates a block diagram of a computing system configured to implement one or more aspects of at least one embodiment;

FIG. 2 is a more detailed illustration of the data-generation engine, management engine, and execution engine of FIG. 1, according to at least one embodiment;

FIG. 3 illustrates a flow diagram of a method for generating a mathematical reasoning dataset, according to at least one embodiment;

FIG. 4A illustrates inference and/or training logic, according to at least one embodiment;

FIG. 4B illustrates inference and/or training logic, according to at least one embodiment;

FIG. 5 illustrates training and deployment of a neural network, according to at least one embodiment;

FIG. 6A is a block diagram of an example generative language model system suitable for use in implementing some embodiments of the present disclosure;

FIG. 6B is a block diagram of an example generative language model that includes a transformer encoder-decoder suitable for use in implementing some embodiments of the present disclosure;

FIG. 6C is a block diagram of an example generative language model that includes a decoder-only transformer architecture suitable for use in implementing some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

As discussed herein, language models (LMs)—such as large language models (LLMs), vision language models (VLMs), multi-modal language models, etc.—are trained on vast datasets of content and include large numbers of parameters that allow the LMs to perform a wide range of tasks using the content. However, conventional approaches for training and prompting LMs typically lead to suboptimal mathematical reasoning abilities in the LMs.

To address the above limitations, the disclosed techniques synthesize a mathematical reasoning dataset that includes mathematical problems paired with one or more corresponding solutions. The solutions may include a masked solution that specifies a series of steps for solving the corresponding mathematical problem in text, code, images, audio, and/or another format. Within the masked solution, numbers in intermediate computations are replaced with symbols. The solutions may also, or instead, include an unmasked solution that specifies a series of steps for solving the corresponding mathematical problem in text, code, images, audio, and/or another format, where intermediate computations are not masked using symbols. For example, a mathematical problem in the dataset may include a question of “Lynne bought 7 books about cats and 2 books about the solar system. She also bought 3 magazines. Each book cost $7 and each magazine cost $4. How much did Lynne spend in all?” The mathematical problem may be paired with a ground-truth text solution of “Lynne bought a total of 7+2=9 books. The books cost Lynne 9×7=$63. For 3 magazines, Lynne spent 3×4=$12. In total, Lynne spent 63+12=$75.” The ground-truth text solution may be converted into a masked text solution of “Lynne bought a total of 7+2=M books. The books cost Lynne M×7=N. For 3 magazines, Lynne spent 3×4=P. In total, Lynne spent N+P=Q.”

To generate the masked solutions, a few-shot prompt may be inputted into a LM (or another type of machine learning model). The few-shot prompt includes an instruction for performing a solution masking task, a set of example mathematical problems, a set of example ground-truth solutions to the example mathematical problems, and a set of example masked solutions corresponding to the example ground-truth solutions. The few-shot prompt also includes a mathematical problem and a ground-truth solution to the mathematical problem to be masked. Given this few-shot prompt, the LM may generate a set of one or more masked solutions corresponding to the ground-truth solution.

One or more of the masked solutions may be selected for inclusion in a subsequent few-shot prompt that is used by a corresponding LM (or another type of machine learning model) to generate a solution to the mathematical problem. For example, the set of masked solutions may be filtered and/or ranked based on length, counts of numbers in the masked solutions, inclusion of the answer to the mathematical problem in the masked solutions, and/or other criteria. The subsequent few-shot prompt may then be populated with a set of example mathematical problems, example (masked or unmasked) solutions to the example mathematical problems in a first format (e.g., text), example ground-truth solutions to the example mathematical problems in a second format (e.g., a code-interpreter format that includes a combination of code and text), the mathematical problem, one or more of the filtered and/or ranked masked solutions, and an instruction to generate a solution to the mathematical problem in the same format as the example ground-truth solutions. The subsequent few-shot prompt may then be inputted into a LM (which can be the same LM used to generate the masked solutions and/or a different LM) to cause the LM to generate a solution in the specified format.

If a solution generated by the LM is correct, includes code that executes, and/or meets other criteria, the solution and corresponding mathematical problem are added to a mathematical reasoning dataset. The process may be repeated with additional mathematical problems and masked solutions to populate the mathematical reasoning dataset with a variety of mathematical problems paired with respective masked and/or unmasked solutions. The mathematical reasoning dataset may then be used to fine-tune a LM (or another type of machine learning model), generate few-shot prompts for a pre-trained general-purpose LM, evaluate the mathematical reasoning performance of an LM and/or another type of machine learning model, and/or otherwise guide an LM on mathematical reasoning tasks.

One technical advantage of the disclosed techniques relative to prior approaches is the ability to use LMs (or other types of machine learning models) to synthesize step-by-step solutions to a variety of mathematical problems. Consequently, the disclosed techniques address the inability of LMs to generate solutions to mathematical problems, the tendency of LMs to generate incorrect and/or “shortcut” solutions that do not use mathematical principles to arrive at correct answers to mathematical problems, and/or other challenges encountered by conventional approaches to leveraging LMs to synthesize solutions to mathematical problems. Another technical advantage of the disclosed techniques is the ability to train, fine-tune, prompt, and/or otherwise improve the performance of LMs and/or other type of machine learning models on mathematical reasoning tasks using the synthesized mathematical reasoning dataset. Accordingly, the disclosed techniques can be used to improve the mathematical reasoning capabilities of these machine learning models and/or the use of the machine learning models in applications and environments involving mathematical reasoning.

Although the language models primarily described herein are LLMs, this is not intended to be limiting, and any other type of language model (e.g., VLM, MMLM, etc.) and/or other model type may be used to perform the processes described herein.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as LLMs that may process text, audio, and/or image data, systems for performing light transport simulation, systems for performing collaborative content creation for 3D assets, systems implemented at least partially using cloud computing resources, systems for performing generative AI operations, and/or other types of systems.

The above examples are not in any way intended to be limiting. As persons skilled in the art will appreciate, as a general matter, the techniques for automatically generating dialogue flows from unlabeled conversation data can be implemented in any suitable application.

### System Overview

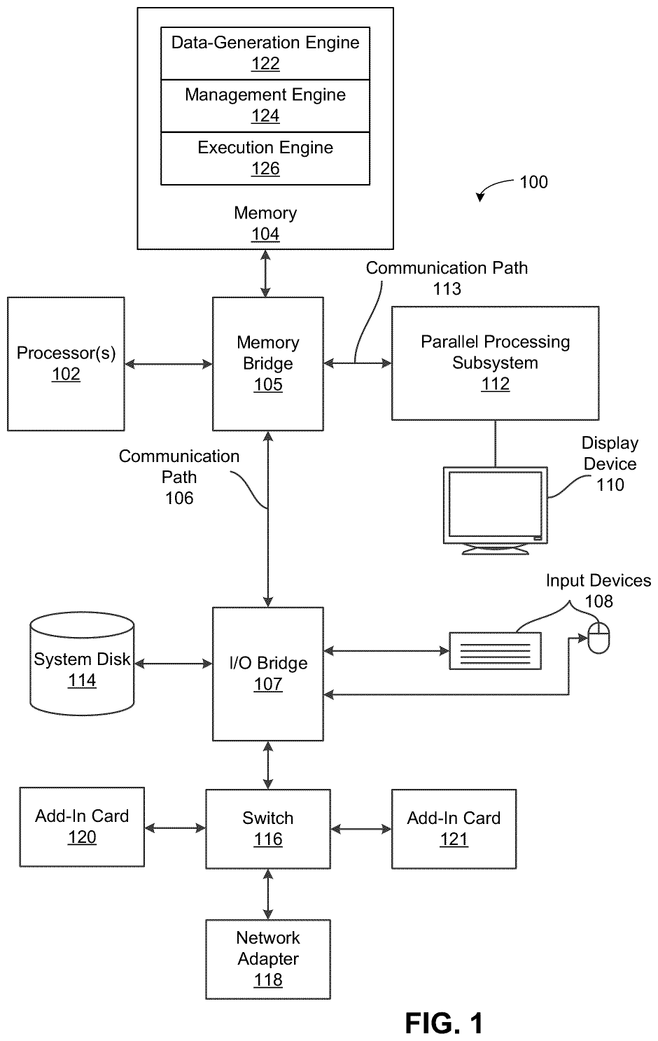

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include a data-generation engine 122, a management engine 124, and an execution engine 126, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, data-generation engine 122, management engine 124, and execution engine 126 include functionality to synthesize a mathematical reasoning dataset that includes mathematical problems paired with one or more corresponding solutions. The solutions may include a masked solution that specifies a series of steps for solving the corresponding mathematical problem in text, code, and/or another format. Within the masked solution, numbers in intermediate computations are replaced with symbols. The solutions may also, or instead, include an unmasked solution that specifies a series of steps for solving the corresponding mathematical problem in text, code, and/or another format, where intermediate computations are not masked using symbols. For example, a mathematical problem in the dataset may include a question of “Lynne bought 7 books about cats and 2 books about the solar system. She also bought 3 magazines. Each book cost $7 and each magazine cost $4. How much did Lynne spend in all?” The mathematical problem may be paired with a ground-truth unmasked solution of “Lynne bought a total of 7+2=9 books. The books cost Lynne 9×7=$63. For 3 magazines, Lynne spent 3×4=$12. In total, Lynne spent 63+12=$75.” The ground-truth text solution may be converted into a masked solution of “Lynne bought a total of 7+2=M books. The books cost Lynne M×7=N. For 3 magazines, Lynne spent 3×4=P. In total, Lynne spent N+P=Q.”

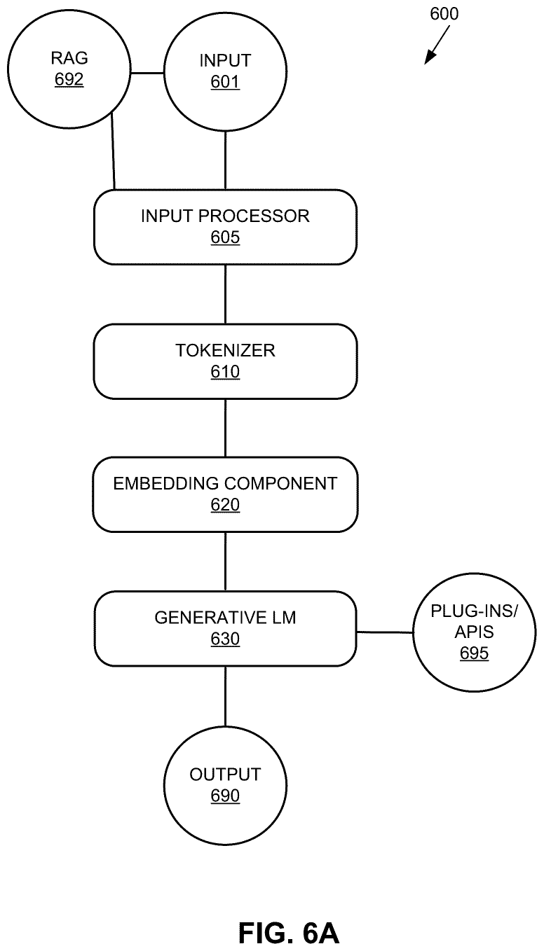

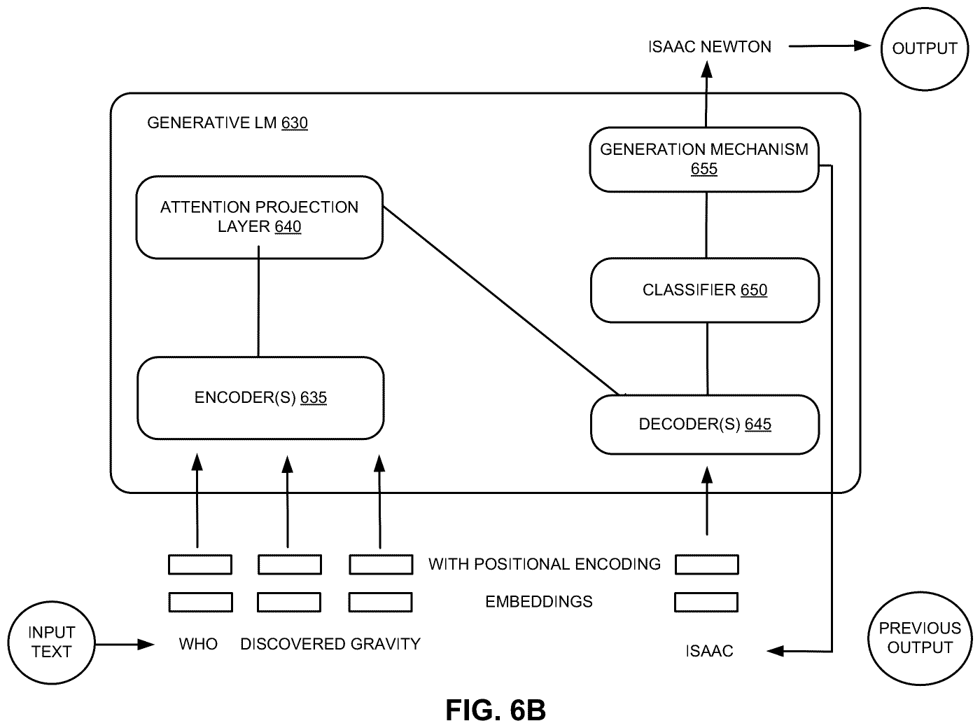

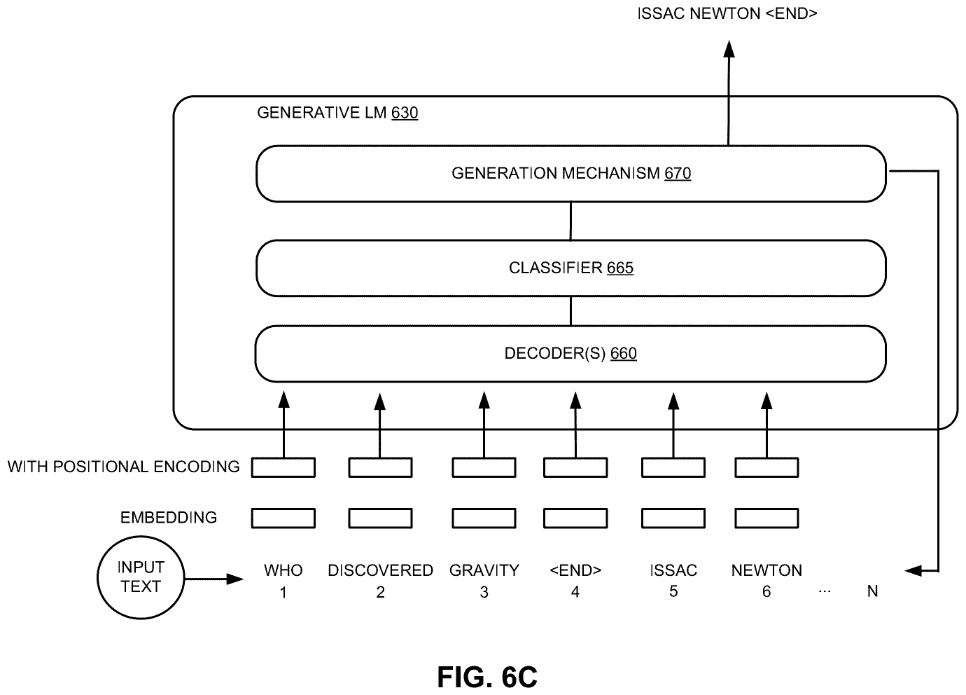

Data-generation engine 122 includes various processing steps and/or stages that are implemented using prompts to LLMs, VLMs, multi-modal language models, and/or other (e.g., language) model types (as discussed herein with respect to FIGS. 6A-6C). For example, data-generation engine 122 may generate masked text solutions by inputting a few-shot prompt may into an LLM. The few-shot prompt may include an instruction for performing a solution masking task, a set of example mathematical problems, a set of example ground-truth solutions to the example mathematical problems, and/or a set of example masked solutions corresponding to the example ground-truth solutions. The few-shot prompt may also include a mathematical problem and a ground-truth solution to the mathematical problem to be masked. Given this few-shot prompt, the LLM may generate a set of one or more masked solutions corresponding to the ground-truth solution.

Data-generation engine 122 may also select one or more of the masked solutions for inclusion in a subsequent few-shot prompt that is used by a corresponding LLM to generate an unmasked solution to the mathematical problem. For example, a set of masked solutions to a given mathematical problem may be filtered based on length, occurrences of numbers in the masked solutions, inclusion of the answer to the mathematical problem in the masked solutions, and/or other criteria. The subsequent few-shot prompt may then be populated with a set of example mathematical problems, example (masked or unmasked) solutions to the example mathematical problems in a first format (e.g., text), example ground-truth solutions to the example mathematical problems in a second format (e.g., a code-interpreter format that includes a combination of code and natural language reasoning), the mathematical problem, one or more of the filtered masked solutions, and an instruction to generate a solution to the mathematical problem in the same format as the example ground-truth solutions. The subsequent few-shot prompt may then be inputted into an LLM (which can be the same LLM used to generate the masked solutions and/or a different LLM) to cause the LLM to generate a solution in the specified format.

If a solution generated by the LLM is correct, includes code that executes, and/or meets other criteria, data-generation engine 122 adds the solution and corresponding mathematical problem to a mathematical reasoning dataset. The process may be repeated with additional mathematical problems and masked solutions to populate the mathematical reasoning dataset with a variety of mathematical problems paired with respective solutions.

Management engine 124 coordinates the operation of data-generation engine 122 in generating the mathematical reasoning dataset. For example, management engine 124 may specify mathematical problems, answers to the mathematical problems, and/or ground-truth solutions to the mathematical problems for inclusion in the mathematical reasoning dataset. Management engine 124 may also, or instead, generate prompts that are used by data-generation engine 122 to effect the generation of masked and/or unmasked solutions to the mathematical problems. Management engine 124 may also, or instead, specify parameters that are used to filter the generated masked and/or unmasked solutions from the prompts and/or the mathematical reasoning dataset.

Execution engine 126 uses the mathematical reasoning dataset to improve the performance of LLMs and/or other machine learning models or applications on mathematical reasoning tasks. For example, execution engine 126 may use the mathematical reasoning dataset to fine-tune an LLM, generate few-shot prompts for a pre-trained general-purpose LLM, evaluate the mathematical reasoning performance of an LLM, and/or otherwise guide an LLM on mathematical reasoning tasks. Data-generation engine 122, management engine 124, and execution engine 126 are described in further detail below.

### Masked Reference Solutions for Mathematical Reasoning Using Large Language Models

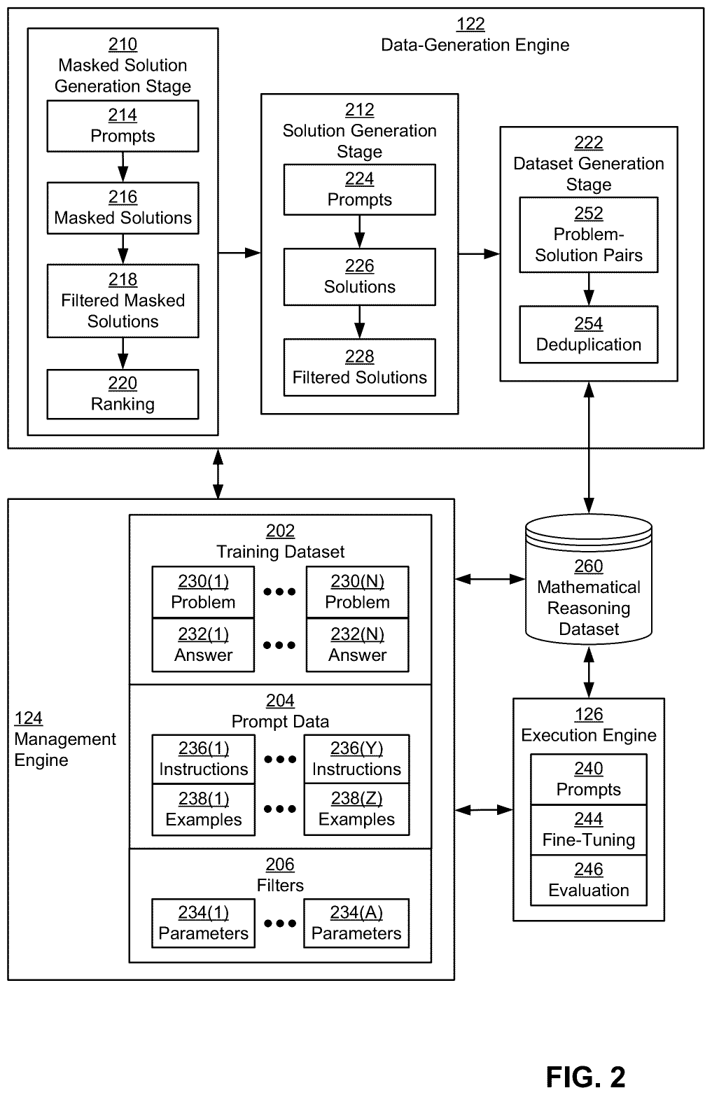

FIG. 2 is a more detailed illustration of data-generation engine 122, management engine 124, and execution engine 126 of FIG. 1, according to at least one embodiment. As discussed herein, data-generation engine 122, management engine 124, and execution engine 126 include functionality to generate and use a mathematical reasoning dataset 260 that includes a set of problem-solution pairs 252. Each problem-solution pair includes a mathematical problem 230(1)-230(X) (each of which is referred to individually herein as problem 230) from a training dataset 202 and a generated solution that includes a series of steps for solving the mathematical problem in text, code, and/or another format.

For example, a problem-solution pair may include a mathematical problem 230 of “A department store displays a 20% discount on all fixtures. What will be the new price of a 25 cm high bedside lamp that was worth $120?” The problem-solution pair may also include the following solution in a “code interpreter” format that includes a mix of natural language and code blocks:

```
Let's solve this problem using Python code.
  <llm-code>
  discount_percent = 20
  price_before_discount = 120
  discount = discount_percent / 100
  discount_amount = price_before_discount * discount price = price_before_discount −
  discount_amount price
  </llm-code>
  <llm-code-output>
  96.0
  </llm-code-output>
So the new price of the lamp is [symbol]   dollars.
```

In the above solution, the start and end of a code block is denoted by the strings “<llm-code>” and “</llm-code>,” respectively. The execution of a code block is denoted by the starting string “<llm-code-output>” and ending string “</llm-code-output>.” The answer to the problem is included in a box on the last line. This box may be generated via a “\boxed{ }” command that includes “96” as an argument.

Data-generation engine 122 includes multiple stages that are executed to generate mathematical reasoning dataset 260. The operation of these stages is controlled via training dataset 202, prompt data 204, filters 206, and/or other data provided by management engine 124.

Training dataset 202 include mathematical problems 230 paired with corresponding answers 232(1)-232(X) (each of which is referred to individually herein as answer 232). For example, training dataset 202 may be represented by X={(q₁, a₁), . . . , (q_{N}, a_{N})}, where qᵢ and aᵢ denote the i^{th} problem 230 and answer 232, respectively, and N represents the size of training dataset 202 (e.g., the number of problems 230 paired with answers 232 in training dataset 202). Training dataset 202 may also include an optional text solution tᵢ that uses natural language (or another format) to describe a trajectory from qᵢ to aᵢ using mathematical principles. Problems 230, answers 232, and/or solutions in training dataset 202 may be collected and/or aggregated from various sources, such as (but not limited to) public datasets, textbooks, exams, courses, humans, and/or machine learning models.

Prompt data 204 includes instructions 236(1)-236(Z) (each of which is referred to individually herein as instructions 236) that are provided to large language models (LLMs), vision language models (VLMs), multi-modal language models, and/or other types of machine learning models. Each set of instructions 236 may define a task to be performed by a machine learning model, input into the task, output of the task, and/or other parameters associated with the task. For example, instructions 236 may specify that a machine learning model is to generate data related to mathematical reasoning dataset 260 and/or evaluate the data generated by a different machine learning model based on various criteria.

Prompt data 204 also includes various sets of examples 238(1)-238(Z) (each of which is referred to individually herein as examples 238) related to problems 230 and/or answers 232 in training dataset 202. For example, examples 238 may include a subset of problems 230 from training dataset 202, answers 232 to the subset of problems 230, and/or masked and/or unmasked solutions to the subset of problems 230 in one or more formats (e.g., as included in training dataset 202, manually written by users, etc.).

Filters 206 include various sets of parameters 234(1)-234(A) (each of which is referred to individually herein as parameters 234) that can be used to filter data generated by data-generation engine 122. Filters 206 and/or individual sets of parameters 234 associated with filters 206 may be user-specified, determined by one or more machine learning models, and/or determined based on use cases and/or requirements associated with mathematical reasoning dataset 260.

As shown in FIG. 2, data-generation engine 122 initially performs a masked solution generation stage 210, in which a set of prompts 214 to machine language models is used to generate masked solutions 216 to problems 230 in training dataset 202. Prompts 214 include instructions 236 and/or examples 238 related to the generation of masked solutions 216 to problems 230.

In one or more embodiments, each of prompts 214 includes a few-shot prompt with the following representation:

$${𝒥}_{mask} ( {q}_{1} , {t}_{1} , {t}_{1}^{mask} ) , … , ( {q}_{K} , {t}_{K} , {t}_{K}^{mask} ) , {q}^{′} , {t}^{′} \qquad ( 1 )$$

In the above equation, [symbol] represents a given instruction 236 to generate a masked solution for a corresponding problem 230 q′ with a text solution t′, {q₁, . . . , q_{K}} denotes K example problems 230 representative of training dataset 202 (e.g., problems 230 from training dataset 202, problems 230 that are similar to those found in training dataset 202, etc.), {t₁, . . . , t_{K}} represent unmasked text solutions to the example problems 230, and {t₁^{mask}, . . . , t_{K}^{mask}} represent masked text solutions corresponding to {t₁, . . . , t_{K}}.

For example, a prompt that is used in masked solution generation stage 210 may include the instructions 236 of “Here are some examples of questions, solutions, and their masked solutions followed by a new question and solution that you need to mask. The goal is to ensure that the masked solution doesn't have any of the numerical values not mentioned in the question. So intermediate values calculated in the solution are to be masked by single letter capital variables, such as M, N.” The prompt may also include K example problems 230, K corresponding text solutions, K corresponding masked text solutions, a new problem 230 for which a masked solution is to be generated, and/or an unmasked “reference” text solution to the new problem 230.

During masked solution generation stage 210, data-generation engine 122 may input each of prompts 214 into an LLM and/or another type of machine learning model. In response to the inputted prompts 214, the machine learning model(s) may generate a masked solution to each new problem 230. Data-generation engine 122 may also reinput a given prompt into the same machine learning model and/or a different machine learning model to generate multiple masked solutions to the same problem 230.

The operation of data-generation engine 122 during masked solution generation stage 210 may be illustrated using an example new problem 230 of “A box contains 5 white balls and 6 black balls. Two balls are drawn out of the box at random. What is the probability that they both are white?” Within training dataset 202, the example problem 230 is paired with a reference solution of “There are $\binom{11}{2}=55$ combinations of two balls that can be drawn. There are $\binom{5}{2}=10$ combinations of two white balls that can be drawn. So the probability that two balls pulled out are both white is $\dfrac{10}{55}=\boxed{\dfrac{2}{11}}$.” Data-generation engine 122 may input a prompt that includes the above instructions 236 for performing a solution masking task, the above problem 230, the above reference solution, and additional examples of mathematical problems 230, reference solutions, and masked solutions into an LLM. In response to the inputted prompt, the LLM may output a masked solution of “There are M combinations of two balls that can be drawn. There are N combinations of two white balls that can be drawn. So the probability that two balls pulled out are both white is $\dfrac{N}{M}=\boxed{\frac{0}{P}}$.”

After masked solutions 216 to some or all problems 230 in training dataset 202 have been generated using prompts 214, data-generation engine 122 uses one or more sets of parameters 234 included in filters 206 to generate a corresponding set of filtered masked solutions 218. These filtered masked solutions 218 may include a subset of masked solutions 216 that meet criteria represented by the set(s) of parameters 234 in filters 206.

For example, data-generation engine 122 may use prompts 214 to generate N masked solutions 216 for each problem 230 in training dataset 202. Next, data-generation engine 122 may use one or more sets of parameters 234 to filter masked solutions 216 by length (e.g., to remove masked solutions 216 that deviate from an average, median, quantile, and/or other representative length for a given problem 230, type of problem 230, and/or set of problems 230 by more than a threshold amount). Data-generation engine 122 may also, or instead, use one or more sets of parameters 234 to filter masked solutions 216 that include answers 232 to the corresponding problems (e.g., so that the resulting filtered masked solutions 218 are masking the final answer 232 to each problem 230).

Data-generation engine 122 then generates a ranking 220 of filtered masked solutions 218. For example, data-generation engine 122 may rank filtered masked solutions 218 by ascending counts of numbers, so that filtered masked solutions 218 with fewer numbers (and a higher likelihood of masking intermediate computations) are ranked more highly.

After masked solution generation stage 210 is complete, data-generation engine 122 uses filtered masked solutions 218 and/or ranking 220 as input into a solution generation stage 212. In some embodiments, data-generation engine 122 uses some or all filtered masked solutions 218 in ranking 220 to generate additional prompts 224 to one or more LLMs and/or other types of machine learning models. These prompts 224 are inputted into the machine learning model(s) to cause the machine learning model(s) to generate additional solutions 226 to problems 230 in training dataset 202.

In one or more embodiments, each of prompts 224 includes a few-shot prompt with the following representation:

$$𝒥 ( {q}_{1} , {f}_{1} , {c}_{1} ) , … , ( {q}_{K} , {t}_{K} , {c}_{K} ) , {q}^{′} , {t}^{′ mask} \qquad ( 2 )$$

In the above equation, [symbol] represents a given instruction 236 to generate a solution for a given problem 230 q′ with a masked text solution t′ₘₐₛₖ, {q₁, . . . , q_{K}} denotes K example problems 230 representative of training dataset 202 and/or the given problem 230 to be masked (e.g., problems 230 from training dataset 202, problems that are similar to those in training dataset 202, problems that are similar to the given problem 230 to be masked, problems in the same subject as the given problem 230 to be masked, problems with the same level of difficulty as the given problem 230 to be masked, etc.), {t₁, . . . , t_{K}} represent masked and/or unmasked text solutions to the example problems 230, and {c₁, . . . , c_{K}} represent solutions to the example problems in the desired code interpreter format.

For example, a prompt that is used in solution generation stage 212 may include instructions 236 of “Here are some examples of questions and solutions followed by a new question that you need to solve. Make sure to put the answer (and only the answer) inside \boxed{ }.” The prompt may also include K example problems 230, K corresponding masked and/or unmasked text solutions, K corresponding code interpreter solutions, a new problem 230 for which a solution is to be generated, and/or a masked text solution to the new problem 230.

During solution generation stage 212, data-generation engine 122 may input each of prompts 224 into an LLM and/or another type of machine learning model. In response to the inputted prompts 224, the machine learning model(s) may generate a solution to the new problem 230 in the same format as the example solutions to the example problems 230. Data-generation engine 122 may also reinput a given prompt into the same machine learning model and/or a different machine learning model to generate multiple solutions 226 to the same problem 230.

The operation of data-generation engine 122 during solution generation stage 212 may be illustrated using a new problem 230 of “John is 24 years younger than his dad. The sum of their ages is 68 years. How many years old is John?” Within training dataset 202, the example problem 230 is paired with a reference solution of “Let $j$ be John's age and $d$ be his dad's age. We are trying to find the value of $j$. We can create a system of two equations to represent the given information. They are\n\n\\begin{align*}\nj &=d−24 \\\\\nj+d &=68 †††††n\†end{align*} We want to find $j$, so we need to eliminate $d$ from the equations above. Rewriting the first equation we get $d=j+24$. Substituting this into the second equation to eliminate $d$, we have $j+(j+24)−68$, or $j=22$. Thus, John is $\\boxed{22}$ years old.” During masked solution generation stage 210, data-generation engine 122 may use a machine learning model to convert the reference solution into a corresponding masked reference solution of “Let $j$ be John's age and $d$ be his dad's age. We are trying to find the value of $j$. We can create a system of two equations to represent the given information. They are\n\n\\begin{align*} \nj &=d-24 \\\\\nj+d &=68 \\\\\n\\end{align*} We want to find $j$, so we need to eliminate $d$ from the equations above. Rewriting the first equation we get $d=j+24$. Substituting this into the second equation to eliminate $d$, we have $j+(j+24)=68$, or $j=M$. Thus, John is $\\boxed{M}$ years old.” Data-generation engine 122 may input a prompt that includes the above instructions 236 for generating a solution to the new problem, the above text from the new problem 230, the above masked reference solution, and additional examples of mathematical problems 230 and masked and/or unmasked reference solutions in the code interpreter format into an LLM. In response to the inputted prompt, the LLM may output the following code interpreter solution:

```
To compute John's age, we can use Python's sympy library.
  <llm-code>
  import sympy as sp
  # Let's denote John's age by j
  j = sp.symbols(‘j’)
  # Let's denote John's dad's age by d. John is 24 years younger than his dad
  d = j + 24
  # Sum of their ages is 68
  eq = sp.Eq(j + d, 68)
  # solving for j we get the John's age
  sp.solve(eq, j)
  </llm-code>
  <llm-code-output>
  22
  </llm-code-output>
So John is [symbol]   years old.
```

After solutions 226 to some or all problems 230 in training dataset 202 are generated using prompts 224, data-generation engine 122 uses one or more sets of parameters 234 included in filters 206 to generate a corresponding set of filtered solutions 228. These filtered solutions 228 may include a subset of solutions 226 that meet criteria represented by the set(s) of parameters 234 in filters 206.

For example, data-generation engine 122 may use prompts 224 to generate Nₜₒₜₐₗ solutions 226 for a given problem 230 in training dataset 202. This set of Nₜₒₜₐₗ solutions 226 may include code-based solutions 226 that include a mix of code and text, as well as a set of text-based solutions 226 that do not include code. The number of code-based solutions 226 may be denoted by N_{code}, and the number of text-based solutions 226 may be denoted by Nₜₑₓₜ. Data-generation engine 122 may use a “majority code” filter that removes all text-based solutions 226 if N_{code}>Nₜₑₓₜ. Data-generation engine 122 may also, or instead, use an “any code” filter that removes all text-based solutions 226 if N_{code}>0.

In another example, data-generation engine 122 may use filters 206 to omit “syntactically noisy” solutions 226 from filtered solutions 228. These syntactically noisy solutions 226 may include multiple answers (e.g., in the form of multiple \boxed{ } blocks), include “<llm-code>” strings but lack corresponding “</llm-code>” strings, and/or include “<llm-code-output>” strings but lack corresponding “<. llm-code-output>” strings.

In a third example, data-generation engine 122 may use filters 206 identify solutions 226 that include additional text after the answer (e.g., in a boxed{ } block). Data-generation engine 122 may then “trim” these solutions 226 by removing text that is found after the line of text with the answer (e.g., because.

In a fourth example, data-generation engine 122 may use filters 206 to omit incorrect solutions 226 from filtered solutions 228. These incorrect solutions 226 may include wrong answers, code that results in execution errors, flawed reasoning, and/or incorrect computations. Filters 206 for incorrect solutions 226 may be implemented using keyword and/or string matches, machine learning models, symbolic reasoning techniques, testing techniques, formal verification techniques, and/or other techniques.

After solution generation stage 212 is complete, data-generation engine 122 performs a dataset generation stage 222, in which data-generation engine 122 generates problem-solution pairs 252 that include problems 230 from training dataset 202 paired with the corresponding filtered solutions 228. For example, data-generation engine 122 may pair a given solution included in filtered solutions 228 with the corresponding problem 230. Data-generation engine 122 may also store filtered solutions 228, the corresponding problems 230, and/or mappings between filtered solutions 228 and problems 230 in one or more databases and/or other data stores associated with mathematical reasoning dataset 260.

In some embodiments, data-generation engine 122 performs deduplication 254 of problem-solution pairs 252 prior to adding problem-solution pairs 252 to mathematical reasoning dataset 260. For example, data-generation engine 122 may deduplicate and/or merge problem-solution pairs 252 based on syntactic and/or semantic similarity measures computed between solutions 226 for the same problem 230, clusters of embeddings for solutions 226, and/or other techniques. In another example, data-generation engine 122 may use a fair sampling technique to sample problem-solution pairs 252 for inclusion in mathematical reasoning dataset 260. Under this fair sampling technique, data-generation engine 122 may iterative over problems 230 in a round-robin fashion and generate problem-solution pairs 252 from unpicked filtered solutions 228 for each problem. The resulting mathematical reasoning dataset 260 may thus include a more balanced representation of problems 230 than a mathematical reasoning dataset 260 that is generated via a naïve sampling strategy, in which easier problems with larger numbers of solutions are overrepresented and harder problems with fewer solutions are underrepresented.

While the operation of data-generation engine 122 has been discussed above with respect to a specific ordering of stages and/or operations within each stage, it will be appreciated that data-generation engine 122 may generate mathematical reasoning dataset 260 using a different set of stages, a different set of operations within each stage, a different ordering of stages, and/or a different ordering of operations within each stage. For example, data-generation engine 122 may apply various types of filters 206 to problems 230, masked solutions 216, prompts 214 and/or 224, solutions 226, and/or problem-solution pairs 252. In another example, data-generation engine 122 may tailor the generation of prompts 214 and/or 224, masked solutions 216, ranking 220, solutions 226, and/or problem-solution pairs 252 to a given type of mathematical problem 230 (e.g., a mathematical subject), a difficulty level associated with a certain set of mathematical problems 230, and/or other attributes associated with mathematical problems 230. In a third example, data-generation engine 122 may perform deduplication of various types of data generated by data-generation engine 122 before additional processing is performed using the data. In a fourth example, data-generation engine 122 may omit, reorder, add, and/or modify stages and/or operations within each stage to tailor the generation of masked solutions 216 and/or solutions 226 to available resources, a “target” number of problems 230, a “target” coverage of problems 230 by the generated masked solutions 216 and/or solutions 226, and/or other priorities or constraints. In a fifth example, data-generation engine 122 may pair problems 230 in mathematical reasoning dataset 260 with the corresponding masked solutions 216 and/or filtered masked solutions 218, in lieu of or in addition to pairing problems 230 with unmasked solutions 226 and/or filtered solutions 228.

Execution engine 126 incorporates problem-solution pairs 252, mathematical reasoning dataset 260, and/or other data outputted by data-generation engine 122 into various use cases related to mathematical reasoning. First, execution engine 126 may incorporate various portions of mathematical reasoning dataset 260 into prompts 240 associated with LLMs, VLMs, and/or other types of machine learning models. For example, execution engine 126 may generate, as input into a machine learning model, a few-shot prompt that includes a certain number of “example” problem-solution pairs 252 from mathematical reasoning dataset 260, as well as a new mathematical problem to be solved by the machine learning model. During generation of this few-shot prompt, execution engine 126 may select problem-solution pairs 252 that are similar in subject matter, difficulty, and/or other attributes to the new mathematical problem. After the few-shot prompt is inputted into the machine learning model, execution engine 126 may receive a solution to the new mathematical problem as output of the machine learning model.

Execution engine 126 may also, or instead, perform fine-tuning 244 of the machine learning model(s) using mathematical reasoning dataset 260. For example, execution engine 126 may input some or all problems 230 from mathematical reasoning dataset 260 into the machine learning model(s) and obtain corresponding training output that includes predictions by the machine learning model(s) of solutions to the inputted problems 230. Execution engine 126 may compute one or more losses (e.g., cross entropy loss, triplet loss, sequence loss, etc.) between the training output and solutions 226 paired with the inputted problems 230 from mathematical reasoning dataset 260. Execution engine 126 may then use a training technique (e.g., gradient descent and backpropagation, low rank adaptation, etc.) to iteratively update parameters of the machine learning model(s) in a way that reduces the loss(es). After fine-tuning of the machine learning model(s) is complete, execution engine 126 may input, into the machine learning model(s), a new mathematical problem and a zero-shot prompt of “You're an expert Python programmer and mathematician. Help the user to solve this problem using code when necessary. Make sure to put the answer (and only the answer) inside \boxed{ }.” Execution engine 126 may then obtain a solution to the new mathematical problem as corresponding output of the machine learning model(s).

Execution engine 126 may also, or instead, use mathematical reasoning dataset 260 to perform evaluation 246 of the machine learning model(s). For example, execution engine 126 may generate a prompt and/or other input that includes a mathematical problem 230 from mathematical reasoning dataset 260. Execution engine 126 may use an LLM and/or another type of machine learning model to convert the input into a solution to the mathematical problem 230. Execution engine 126 may also determine the performance of the machine learning model in solving the mathematical problem 230 based on a similarity between the solution and existing solutions to the mathematical problem in mathematical reasoning dataset 260, a correctness of the solution (e.g., as evaluated by a human, machine learning model, testing technique, formal verification technique, etc.), and/or other criteria. Execution engine 126 may repeat the process with additional prompts 240 and/or machine learning models (e.g., with or without fine-tuning 244 of a given machine learning model) to determine prompt engineering, fine-tuning, and/or other techniques that result in the best mathematical reasoning performance for a given type of mathematical problem, set of mathematical problems, machine learning model, and/or type of machine learning model.

While the operation of data-generation engine 122, management engine 124, and execution engine 126 has been described with respect to improving mathematical reasoning, it will be appreciated that the functionality of data-generation engine 122, management engine 124, and execution engine 126 may be adapted to other types of data and/or tasks. For example, data-generation engine 122, management engine 124, and execution engine 126 may be used to generate masked solutions, solutions, and/or datasets related to other types of tasks and/or problems, such as (but not limited to) logical reasoning, circuit design, algorithm design and/or analysis, optimization, reading comprehension, different types of writing, analytical reasoning, critical reasoning, data analysis, science, history, foreign languages, and/or literary analysis. In another example, data-generation engine 122, management engine 124, and execution engine 126 may be used to generate masked versions of images, audio, video, text, biochemical data, sensor data, medical data, three-dimensional (3D) data (e.g., computer aided design (CAD) data, USD data (e.g., for NVIDIA's OMNIVERSE or other collaborative content generation/sharing/interactive platforms, etc.), simulation data, and/or other types of data to improve the performance of machine learning models that are trained, fine-tuned, and/or prompted using the masked data.

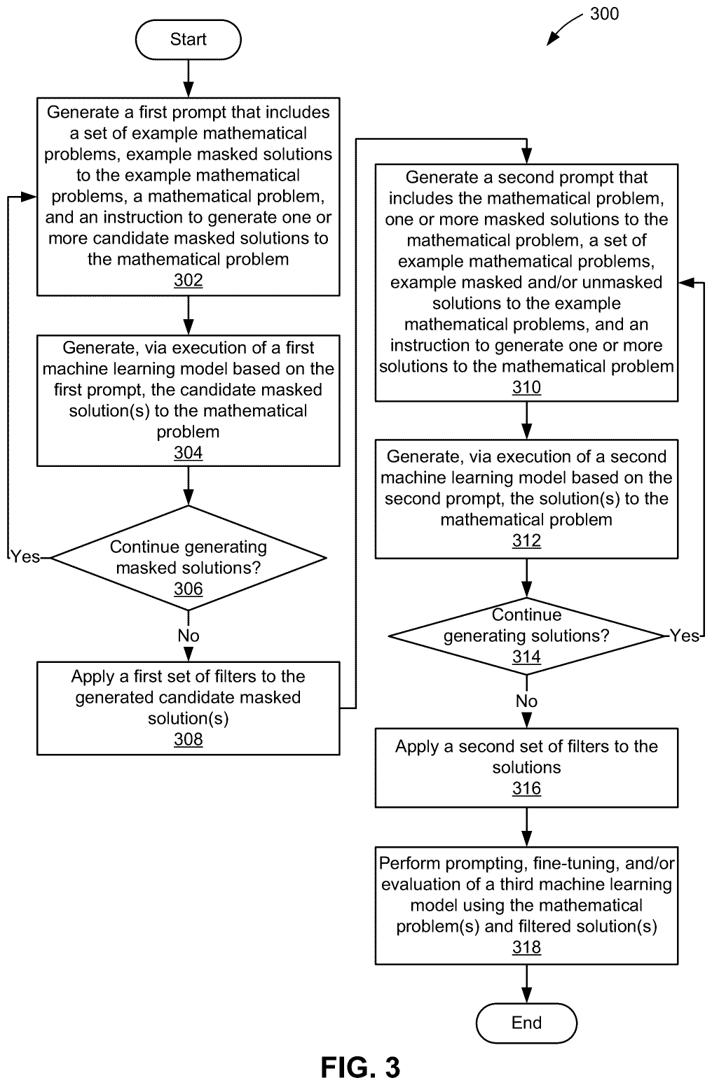

Now referring to FIG. 3, each block of method 300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 300 is described, by simulated way of example, with respect to the systems of FIGS. 1-2. However, these methods may additionally or alternatively be executed by any one system, or any combination of systems, including, but not limited to, those described herein. Further, the operations in method 300 may be omitted, repeated, and/or performed in any order without departing from the scope of the present disclosure.

FIG. 3 illustrates a flow diagram of a method 300 for performing mathematical reasoning using machine learning models. As shown in FIG. 3, method 300 begins with operation 302, in which management engine 124 generates a first prompt that includes a set example mathematical problems, example masked solutions to the example mathematical problems, a mathematical problem, and an instruction to generate one or more candidate masked solutions to the mathematical problem. For example, management engine 124 may obtain the mathematical problem from a training dataset and the example mathematical problems and masked solutions from a “reference” dataset for the mathematical problem (e.g., a dataset associated with a subject, level of difficulty, and/or another attribute of the mathematical problem). Management engine 124 may also combine the mathematical problem, example mathematical problems and masked solutions, and instruction into the first prompt.

In operation 304, data-generation engine 122 generates, via execution of a first machine learning model based on the first prompt, the candidate masked solution(s) to the mathematical problem. For example, data-generation engine 122 may input the first prompt into an LLM, VLM, and/or another type of machine learning model. In response to the inputted first prompt, the machine learning model may generate the candidate masked solution(s).

In operation 306, data-generation engine 122 and/or management engine 124 determine whether or not to continue generating masked solutions. For example, data-generation engine 122 and/or management engine 124 may determine that masked solutions should continue to be generated while the training dataset includes one or more mathematical problems that do not have a certain number of masked solutions. While data-generation engine 122 and/or management engine 124 determine that generation of masked solutions for mathematical problems is to continue, data-generation engine 122 and/or management engine 124 repeat operations 302 and 304 to continue generating (i) prompts associated with the mathematical problems and (ii) masked solutions to the mathematical problems.

After data-generation engine 122 and/or management engine 124 determine that masked solutions are no longer to be generated, data-generation engine 122 performs operation 308, in which data-generation engine 122 applies a first set of filters to the generated candidate masked solution(s). For example, data-generation engine 122 may filter a given set of candidate masked solutions for a mathematical problem based on the length of each candidate masked solution, the presence of the answer to the mathematical problem in a given candidate masked solution, and/or the count of numbers in each candidate masked solution. Data-generation engine 122 may also rank the filtered candidate solutions by ascending counts of numbers in the filtered candidate solutions.

In operation 310, management engine 124 generates a second prompt that includes the mathematical problem, one or more masked solutions to the mathematical problem, a set example mathematical problems, example masked and/or unmasked solutions to the example mathematical problems, and an instruction to generate one or more solutions to the mathematical problem. For example, management engine 124 may obtain the masked solution(s) to the mathematical problem as one or more highest-ranked masked solutions in the ranking generated during operation 308. Management engine 124 may also obtain a set of example mathematical problems and corresponding masked and/or unmasked solutions that are associated with a subject, level of difficulty, and/or other attributes of the mathematical problem and/or a desired format of the solution to the mathematical problem. Management engine 124 may also combine the mathematical problem, masked solution(s) to the mathematical problem, example mathematical problems and corresponding masked and/or unmasked solutions, and instruction into the second prompt.

In operation 312, data-generation engine 122 generates, via execution of a second machine learning model based on the second prompt, the solution(s) to the mathematical problem. For example, data-generation engine 122 may input the second prompt into an LLM, VLM, and/or another type of machine learning model. In response to the inputted second prompt, the machine learning model may generate the solution(s) to the mathematical problem.

In operation 314, data-generation engine 122 and/or management engine 124 determine whether or not to continue generating solutions to mathematical problems. For example, data-generation engine 122 and/or management engine 124 may determine that solutions should continue to be generated while the training dataset includes one or more mathematical problems that do not have a certain number of generated solutions. While data-generation engine 122 and/or management engine 124 determine that generation of solutions for mathematical problems is to continue, data-generation engine 122 and/or management engine 124 repeat operations 310 and 312 to continue generating (i) prompts associated with the mathematical problems and (ii) solutions to the mathematical problems.

After data-generation engine 122 and/or management engine 124 determine that solutions are no longer to be generated, data-generation engine 122 performs operation 316, in which data-generation engine 122 applies a second set of filters to the solutions. For example, data-generation engine 122 may filter solutions that are incorrect, include incorrect answers, do not include executable code, do not include code, include multiple answers, include incorrect formatting, and/or are associated with other “undesirable” attributes. Data-generation engine 122 may also, or instead, filter and/or sample the solutions in a way that balances the distribution of solutions across the mathematical problems. Data-generation engine 122 may also, or instead, deduplicate and/or merge the solutions based on semantic similarity and/or other criteria.

In operation 318, execution engine 126 performs prompting, fine-tuning, and/or evaluation of a third machine learning model using the mathematical problem(s) and filtered solution(s). For example, execution engine 126 may generate a few-shot prompt that includes a set of example mathematical problems, generated solutions to the example mathematical problems, a new mathematical problem, and an instruction to generate a solution to the new mathematical problem. Execution engine 126 may input the few-shot prompt into the third machine learning model to cause the third machine learning model to generate the solution to the new mathematical problem. In another example, execution engine 126 may fine-tune the third machine learning model using some or all problem-solution pairs generated using operations 302, 304, 306, 308, 310, 312, 314, and 316. After fine-tuning is complete, execution engine 126 may use a zero-shot prompt to cause the third machine learning model to generate a solution to a new mathematical problem. In a third example, execution engine 126 may evaluate the performance of the third machine learning model (with or without prompting and/or fine-tuning using the mathematical problem(s) and filtered solution(s)) by inputting a mathematical problem into the third machine learning model and comparing a solution generated by the third machine learning model with a solution that was generated using operations 302, 304, 306, 308, 310, 312, 314, and 316.

In sum, the disclosed techniques synthesize a mathematical reasoning dataset that includes mathematical problems paired with one or more corresponding solutions. The solutions may include a masked solution that specifies a series of steps for solving the corresponding mathematical problem in text, code, and/or another format. Within the masked solution, numbers in intermediate computations are replaced with symbols. The solutions may also, or instead, include an unmasked solution that specifies a series of steps for solving the corresponding mathematical problem in text, code, and/or another format, where intermediate computations are not masked using symbols. For example, a mathematical problem in the dataset may include a question of “Lynne bought 7 books about cats and 2 books about the solar system. She also bought 3 magazines. Each book cost $7 and each magazine cost $4. How much did Lynne spend in all?” The mathematical problem may be paired with a ground-truth text solution of “Lynne bought a total of 7+2=9 books. The books cost Lynne 9×7=$63. For 3 magazines, Lynne spent 3×4=$12. In total, Lynne spent 63+12=$75.” The ground-truth text solution may be converted into a masked text solution of “Lynne bought a total of 7+2=M books. The books cost Lynne M×7=N. For 3 magazines, Lynne spent 3×4=P. In total, Lynne spent N+P=Q.”

To generate the masked solutions, a few-shot prompt may be inputted into an LLM (or another type of machine learning model). The few-shot prompt includes an instruction for performing a solution masking task, a set of example mathematical problems, a set of example ground-truth solutions to the example mathematical problems, and a set of example masked solutions corresponding to the example ground-truth solutions. The few-shot prompt also includes a mathematical problem and a ground-truth solution to the mathematical problem to be masked. Given this few-shot prompt, the LLM may generate a set of one or more masked solutions corresponding to the ground-truth solution.

One or more of the masked solutions may be selected for inclusion in a subsequent few-shot prompt that is used by a corresponding LLM (or another type of machine learning model) to generate a solution to the mathematical problem. For example, the set of masked solutions may be filtered and/or ranked based on length, counts of numbers in the masked solutions, inclusion of the answer to the mathematical problem in the masked solutions, and/or other criteria. The subsequent few-shot prompt may then be populated with a set of example mathematical problems, example (masked or unmasked) solutions to the example mathematical problems in a first format (e.g., text), example ground-truth solutions to the example mathematical problems in a second format (e.g., a code-interpreter format that includes a combination of code and text), the mathematical problem, one or more of the filtered and/or ranked masked solutions, and an instruction to generate a solution to the mathematical problem in the same format as the example ground-truth solutions. The subsequent few-shot prompt may then be inputted into an LLM (which can be the same LLM used to generate the masked solutions and/or a different LLM) to cause the LLM to generate a solution in the specified format.

If a solution generated by the LLM is correct, includes code that executes, and/or meets other criteria, the solution and corresponding mathematical problem are added to a mathematical reasoning dataset. The process may be repeated with additional mathematical problems and masked solutions to populate the mathematical reasoning dataset with a variety of mathematical problems paired with respective masked and/or unmasked solutions. The mathematical reasoning dataset may then be used to fine-tune an LLM (or another type of machine learning model), generate few-shot prompts for a pre-trained general-purpose LLM, evaluate the mathematical reasoning performance of an LLM and/or another type of machine learning model, and/or otherwise guide an LLM on mathematical reasoning tasks.

One technical advantage of the disclosed techniques relative to prior approaches is the ability to use LLMs (or other types of machine learning models) to synthesize step-by-step solutions to a variety of mathematical problems. Consequently, the disclosed techniques address the inability of LLMs to generate solutions to mathematical problems, the tendency of LLMs to generate incorrect and/or “shortcut” solutions that do not use mathematical principles to arrive at correct answers to mathematical problems, and/or other challenges encountered by conventional approaches to leveraging LLMs to synthesize solutions to mathematical problems. Another technical advantage of the disclosed techniques is the ability to train, fine-tune, prompt, and/or otherwise improve the performance of LLMs and/or other type of machine learning models on mathematical reasoning tasks using the synthesized mathematical reasoning dataset. Accordingly, the disclosed techniques can be used to improve the mathematical reasoning capabilities of these machine learning models and/or the use of the machine learning models in applications and environments involving mathematical reasoning.

### Inference and Training Logic

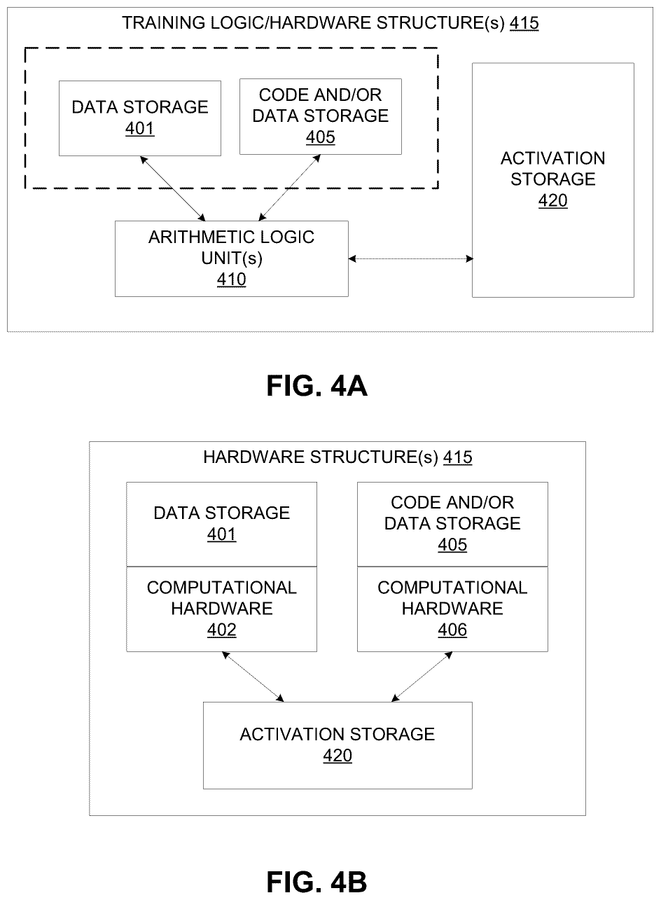

FIG. 4A illustrates inference and/or training logic 415 used to perform inferencing and/or training operations associated with one or more embodiments. Details regarding inference and/or training logic 415 are provided herein in conjunction with at least FIGS. 4A and/or 4B.

In at least one embodiment, inference and/or training logic 415 may include, without limitation, code and/or data storage 401 to store forward and/or output weight and/or input/output data, and/or other parameters to configure neurons or layers of a neural network trained and/or used for inferencing in aspects of one or more embodiments. In at least one embodiment, training logic 415 may include, or be coupled to code and/or data storage 401 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 401 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 401 may be included with other on-chip or off-chip data storage, including a processor's L1, L2, or L3 cache or system memory.

In at least one embodiment, any portion of code and/or data storage 401 may be internal or external to one or more processors or other hardware logic devices or circuits. In at least one embodiment, code and/or code and/or data storage 401 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 401 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 may include, without limitation, a code and/or data storage 405 to store backward and/or output weight and/or input/output data corresponding to neurons or layers of a neural network trained and/or used for inferencing in aspects of one or more embodiments. In at least one embodiment, code and/or data storage 405 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 415 may include, or be coupled to code and/or data storage 405 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 405 may be included with other on-chip or off-chip data storage, including a processor's L1, L2, or L3 cache or system memory. In at least one embodiment, any portion of code and/or data storage 405 may be internal or external to one or more processors or other hardware logic devices or circuits. In at least one embodiment, code and/or data storage 405 may be cache memory, DRAM, SRAM, non-volatile memory (e.g., flash memory), or other storage. In at least one embodiment, a choice of whether code and/or data storage 405 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 401 and code and/or data storage 405 may be separate storage structures. In at least one embodiment, code and/or data storage 401 and code and/or data storage 405 may be a combined storage structure. In at least one embodiment, code and/or data storage 401 and code and/or data storage 405 may be partially combined and partially separate. In at least one embodiment, any portion of code and/or data storage 401 and code and/or data storage 405 may be included with other on-chip or off-chip data storage, including a processor's L1, L2, or L3 cache or system memory.

In at least one embodiment, inference and/or training logic 415 may include, without limitation, one or more arithmetic logic unit(s) (“ALU(s)”) 410, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 420 that are functions of input/output and/or weight parameter data stored in code and/or data storage 401 and/or code and/or data storage 405. In at least one embodiment, activations stored in activation storage 420 are generated according to linear algebraic and or matrix-based mathematics performed by ALU(s) 410 in response to performing instructions or other code, wherein weight values stored in code and/or data storage 405 and/or data storage 401 are used as operands along with other values, such as bias values, gradient information, momentum values, or other parameters or hyperparameters, any or all of which may be stored in code and/or data storage 405 or code and/or data storage 401 or another storage on or off-chip.

In at least one embodiment, ALU(s) 410 are included within one or more processors or other hardware logic devices or circuits, whereas in another embodiment, ALU(s) 410 may be external to a processor or other hardware logic device or circuit that uses them (e.g., a co-processor). In at least one embodiment, ALUs 410 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 401, code and/or data storage 405, and activation storage 420 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 420 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 420 may be cache memory, DRAM, SRAM, non-volatile memory (e.g., flash memory), or other storage. In at least one embodiment, activation storage 420 may be completely or partially within or external to one or more processors or other logical circuits. In at least one embodiment, a choice of whether activation storage 420 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 illustrated in FIG. 4A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4A may be used in conjunction with central processing unit (“CPU”) hardware, graphics processing unit (“GPU”) hardware or other hardware, such as field programmable gate arrays (“FPGAs”).

FIG. 4B illustrates inference and/or training logic 415, according to at least one embodiment. In at least one embodiment, inference and/or training logic 415 may include, without limitation, hardware logic in which computational resources are dedicated or otherwise exclusively used in conjunction with weight values or other information corresponding to one or more layers of neurons within a neural network. In at least one embodiment, inference and/or training logic 415 illustrated in FIG. 4B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4B may be used in conjunction with central processing unit (CPU) hardware, graphics processing unit (GPU) hardware or other hardware, such as field programmable gate arrays (FPGAs). In at least one embodiment, inference and/or training logic 415 includes, without limitation, code and/or data storage 401 and code and/or data storage 405, which may be used to store code (e.g., graph code), weight values and/or other information, including bias values, gradient information, momentum values, and/or other parameter or hyperparameter information. In at least one embodiment illustrated in FIG. 4B, each of code and/or data storage 401 and code and/or data storage 405 is associated with a dedicated computational resource, such as computational hardware 402 and computational hardware 406, respectively. In at least one embodiment, each of computational hardware 402 and computational hardware 406 comprises one or more ALUs that perform mathematical functions, such as linear algebraic functions, only on information stored in code and/or data storage 401 and code and/or data storage 405, respectively, result of which is stored in activation storage 420.

In at least one embodiment, each of code and/or data storage 401 and 405 and corresponding computational hardware 402 and 406, respectively, correspond to different layers of a neural network, such that resulting activation from one storage/computational pair 401/402 of code and/or data storage 401 and computational hardware 402 is provided as an input to a next storage/computational pair 405/406 of code and/or data storage 405 and computational hardware 406, in order to mirror a conceptual organization of a neural network. In at least one embodiment, each of storage/computational pairs 401/402 and 405/406 may correspond to more than one neural network layer. In at least one embodiment, additional storage/computation pairs (not shown) subsequent to or in parallel with storage/computation pairs 401/402 and 405/406 may be included in inference and/or training logic 415.

### Neural Network Training and Deployment

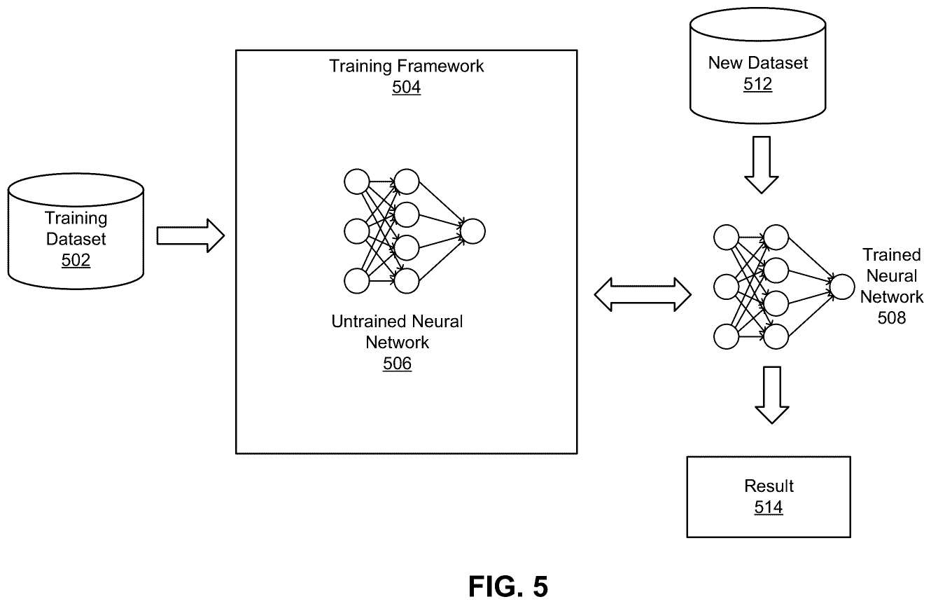

FIG. 5 illustrates training and deployment of a deep neural network, according to at least one embodiment. In at least one embodiment, untrained neural network 506 is trained using a training dataset 502. In at least one embodiment, training framework 504 is a PyTorch framework, whereas in other embodiments, training framework 504 is a TensorFlow, Boost, Caffe, Microsoft Cognitive Toolkit/CNTK, MXNet, Chainer, Keras, Deeplearning4j, or other training framework. In at least one embodiment, training framework 504 trains an untrained neural network 506 and enables it to be trained using processing resources described herein to generate a trained neural network 508. In at least one embodiment, weights may be chosen randomly or by pre-training using a deep belief network. In at least one embodiment, training may be performed in either a supervised, partially supervised, or unsupervised manner.

In at least one embodiment, untrained neural network 506 is trained using supervised learning, wherein training dataset 502 includes an input paired with a desired output for an input, or where training dataset 502 includes input having a known output and an output of neural network 506 is manually graded. In at least one embodiment, untrained neural network 506 is trained in a supervised manner and processes inputs from training dataset 502 and compares resulting outputs against a set of expected or desired outputs. In at least one embodiment, errors are then propagated back through untrained neural network 506. In at least one embodiment, training framework 504 adjusts weights that control untrained neural network 506. In at least one embodiment, training framework 504 includes tools to monitor how well untrained neural network 506 is converging towards a model, such as trained neural network 508, suitable to generating correct answers, such as in result 514, based on input data such as a new dataset 512. In at least one embodiment, training framework 504 trains untrained neural network 506 repeatedly while adjust weights to refine an output of untrained neural network 506 using a loss function and adjustment algorithm, such as stochastic gradient descent. In at least one embodiment, training framework 504 trains untrained neural network 506 until untrained neural network 506 achieves a desired accuracy. In at least one embodiment, trained neural network 508 can then be deployed to implement any number of machine learning operations.

In at least one embodiment, untrained neural network 506 is trained using unsupervised learning, wherein untrained neural network 506 attempts to train itself using unlabeled data. In at least one embodiment, unsupervised learning training dataset 502 will include input data without any associated output data or “ground truth” data. In at least one embodiment, untrained neural network 506 can learn groupings within training dataset 502 and can determine how individual inputs are related to untrained dataset 502. In at least one embodiment, unsupervised training can be used to generate a self-organizing map in trained neural network 508 capable of performing operations useful in reducing dimensionality of new dataset 512. In at least one embodiment, unsupervised training can also be used to perform anomaly detection, which allows identification of data points in new dataset 512 that deviate from normal patterns of new dataset 512.

In at least one embodiment, semi-supervised learning may be used, which is a technique in which in training dataset 502 includes a mix of labeled and unlabeled data. In at least one embodiment, training framework 504 may be used to perform incremental learning, such as through transferred learning techniques. In at least one embodiment, incremental learning enables trained neural network 508 to adapt to new dataset 512 without forgetting knowledge instilled within trained neural network 508 during initial training.

In at least one embodiment, training framework 504 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, Open VINO provides various software functions to execute a program on one or more devices. In at least one embodiment, OpenVINO provides various software functions to execute a program and/or portions of a program on different devices. In at least one embodiment, Open VINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets, systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a VLM, a multi-modal LM, etc.).

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 630 (e.g., LLM/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text with image data, audio data, and/or other types of input data, such as but not limited to those described herein. Taking raw input text as an example, the input processor 605 may prepare raw input text in various ways. For example, the input processor 605 may perform various types of text cleaning to remove noise (e.g., special characters, punctuation, HTML tags, stopwords) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data, the input processor 601 may resize the image data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LLM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

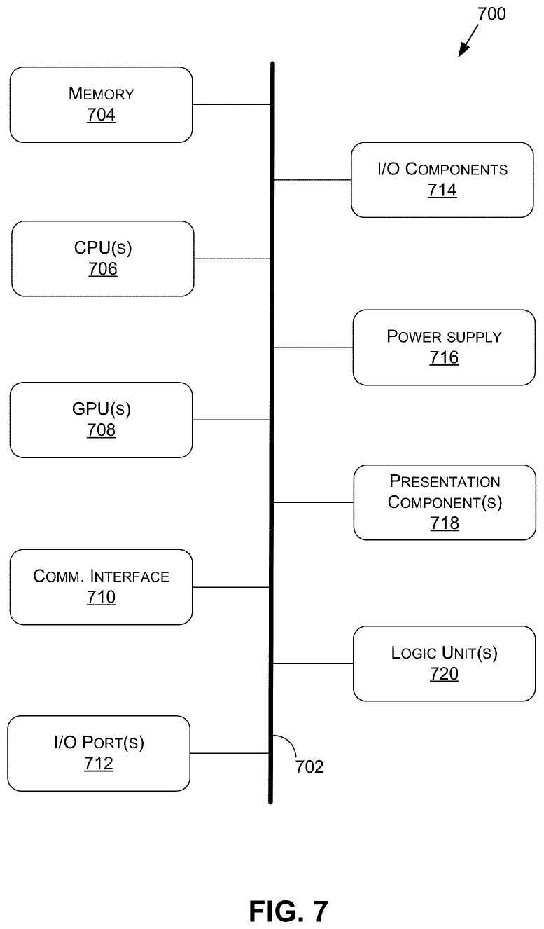

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per sc.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. For example, the CPU(s) may be configured to execute one or more instances of data-generation engine 122, management engine 124, and/or execution engine 126. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, cast, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

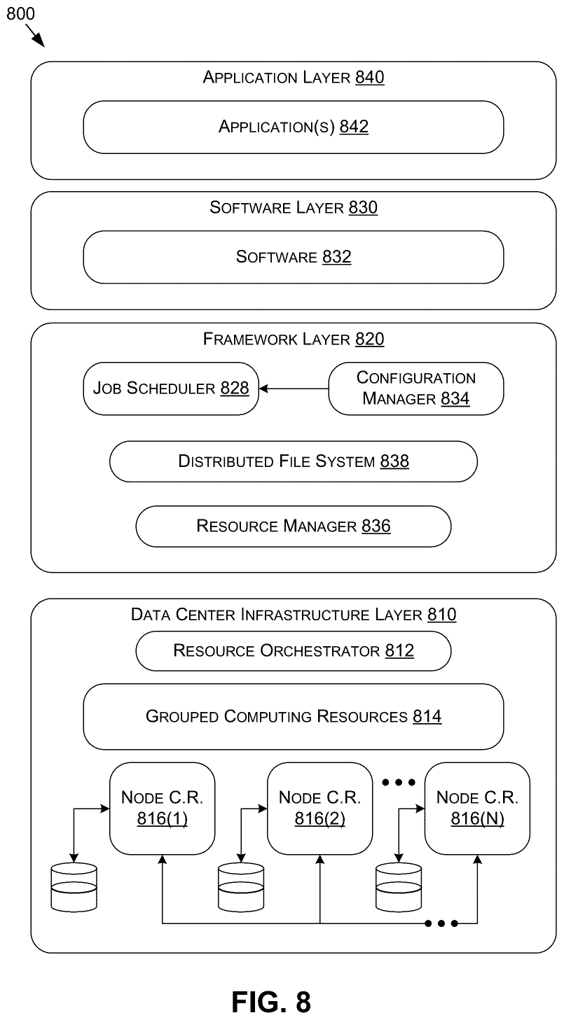

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUS, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software 832 may include, but are not limited to, Internet web page search software, e-mail virus scan software, database software, and streaming video content software. One or more types of software 832 may also, or instead, include data-generation engine 122, management engine 124, and/or execution engine 126.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.
1. In some embodiments, a method comprises inputting a first prompt that includes (i) a set of example mathematical problems, (ii) a set of example masked solutions to the set of example mathematical problems, and (iii) a mathematical problem into a first machine learning model, wherein each masked solution included in the set of example masked solutions includes a set of symbols as substitutes for a set of numbers in a ground-truth solution for a corresponding example mathematical problem included in the set of example mathematical problems; generating, via execution of the first machine learning model and based at least on the first prompt, a set of candidate masked solutions to the mathematical problem; inputting a second prompt that includes (i) the mathematical problem and (ii) at least one masked solution included in the set of candidate masked solutions into a second machine learning model; and generating, via execution of the second machine learning model and based at least on the second prompt, a solution to the mathematical problem.
2. The method of clause 1, further comprising training a third machine learning model using the mathematical problem and the solution.
3. The method of any of clauses 1-2, further comprising determining the at least one masked solution based at least on a set of filters for the set of candidate masked solutions.
4. The method of any of clauses 1-3, wherein the set of filters is associated with at least one of a length of a candidate masked solution included in the set of candidate masked solutions, a presence of an answer to the mathematical problem in the candidate masked solution, or a count of numbers in the candidate masked solution.
5. The method of any of clauses 1-4, wherein the first prompt further includes an instruction to generate the set of candidate masked solutions to the mathematical problem based at least on the set of example mathematical problems and the set of example masked solutions.
6. The method of any of clauses 1-5, wherein the first prompt further includes a set of ground-truth solutions to the set of example mathematical problems and the mathematical problem.
7. The method of any of clauses 1-6, wherein the second prompt further includes (i) a second set of example mathematical problems and (ii) a second set of example solutions to the second set of example mathematical problems.
8. The method of any of clauses 1-7, wherein the set of numbers is associated with a set of intermediate computations in the ground-truth solution.
9. The method of any of clauses 1-8, wherein the first machine learning model includes a large language model (LLM), a vision language model (VLM), or a multi-modal language model (MMLM).
10. The method of any of clauses 1-9, wherein the solution comprises at least one of text or code.
11. In some embodiments, at least one processor comprises processing circuitry to cause performance of operations comprising inputting a first prompt that includes (i) a set of example mathematical problems, (ii) a set of example masked solutions to the set of example mathematical problems, and (iii) a mathematical problem into a first machine learning model, wherein each masked solution included in the set of example masked solutions includes a set of symbols as substitutes for a set of numbers in a ground-truth solution for a corresponding example mathematical problem included in the set of example mathematical problems; generating, via execution of the first machine learning model and based at least on the first prompt, a set of candidate masked solutions to the mathematical problem; inputting a second prompt that includes (i) the mathematical problem and (ii) at least one masked solution included in the set of candidate masked solutions into a second machine learning model; and generating, via execution of the second machine learning model based at least on the second prompt, a solution to the mathematical problem.
12. The at least one processor of clause 11, wherein the operations further comprise generating, via execution of the second machine learning model based at least on a second mathematical problem and a masked solution to the second mathematical problem, a second solution to the second mathematical problem; and training a third machine learning model using the mathematical problem, the solution to the mathematical problem, the second mathematical problem, and the second solution to the second mathematical problem.
13. The at least one processor of any of clauses 11-12, wherein the operations further comprise training a third machine learning model using the mathematical problem and the solution to the mathematical problem; and generating, via execution of the trained third machine learning model, a second solution to a second mathematical problem.
14. The at least one processor of any of clauses 11-13, wherein the operations further comprise applying a set of filters to the solution.
15. The at least one processor of any of clauses 11-14, wherein the set of filters is associated with at least one of a correctness of the solution, an ability to execute code included in the solution, a presence of code in the solution, a formatting of the solution, or a number of answers in the solution.
16. The at least one processor of any of clauses 11-15, wherein the second prompt further includes (i) a second set of example mathematical problems, (ii) a second set of example solutions to the second set of example mathematical problems, and (iii) an instruction to generate the solution to the mathematical problem based at least on the second set of example mathematical problems and the second set of example solutions.
17. The at least one processor of any of clauses 11-16, wherein the first machine learning model and the second machine learning model are the same machine learning model.
18. The at least one processor of any of clauses 11-17, wherein the at least one processor is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implementing one or more vision language models (VLMs); a system implementing one or more multi-modal language models; a system for generating synthetic data; a system for performing one or more generative AI operations; a system incorporating one or more virtual machines (VMs); a system implemented at least partially in a data center; or a system implemented at least partially using cloud computing resources.
19. In some embodiments, a system comprises one or more processing units to generate a solution to a mathematical problem based at least on a masked solution to the mathematical problem, wherein the masked solution is generated using one or more machine learning models based at least on a set of example mathematical problems and a set of example masked solutions to the set of example mathematical problems.
20. The system of clause 19, wherein the system is comprised in at least one of a system for performing simulation operations; a system for performing digital twin operations; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implemented using one or more large language models (LLMs); a system implementing one or more vision language models (VLMs); a system implementing one or more multi-modal language models; a system for generating synthetic data; a system for performing one or more generative AI operations; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating-point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
inputting a first prompt that includes (i) a set of example mathematical problems, (ii) a set of example masked solutions to the set of example mathematical problems, and (iii) a mathematical problem into a first machine learning model, wherein each masked solution included in the set of example masked solutions includes a set of symbols as substitutes for a set of numbers in a ground-truth solution for a corresponding example mathematical problem included in the set of example mathematical problems;
generating, via execution of the first machine learning model and based at least on the first prompt, a set of candidate masked solutions to the mathematical problem;
inputting a second prompt that includes (i) the mathematical problem and (ii) at least one masked solution included in the set of candidate masked solutions into a second machine learning model; and
generating, via execution of the second machine learning model and based at least on the second prompt, a solution to the mathematical problem.

2. The method of claim 1, further comprising training a third machine learning model using the mathematical problem and the solution.

3. The method of claim 1, further comprising determining the at least one masked solution based at least on a set of filters for the set of candidate masked solutions.

4. The method of claim 3, wherein the set of filters is associated with at least one of a length of a candidate masked solution included in the set of candidate masked solutions, a presence of an answer to the mathematical problem in the candidate masked solution, or a count of numbers in the candidate masked solution.

5. The method of claim 1, wherein the first prompt further includes an instruction to generate the set of candidate masked solutions to the mathematical problem based at least on the set of example mathematical problems and the set of example masked solutions.

6. The method of claim 1, wherein the first prompt further includes a set of ground-truth solutions to the set of example mathematical problems and the mathematical problem.

7. The method of claim 1, wherein the second prompt further includes (i) a second set of example mathematical problems and (ii) a second set of example solutions to the second set of example mathematical problems.

8. The method of claim 1, wherein the set of numbers is associated with a set of intermediate computations in the ground-truth solution.

9. The method of claim 1, wherein the first machine learning model includes a large language model (LLM), a vision language model (VLM), or a multi-modal language model (MMLM).

10. The method of claim 1, wherein the solution comprises at least one of text or code.

11. At least one processor comprising:
processing circuitry to cause performance of operations comprising:
inputting a first prompt that includes (i) a set of example mathematical problems, (ii) a set of example masked solutions to the set of example mathematical problems, and (iii) a mathematical problem into a first machine learning model, wherein each masked solution included in the set of example masked solutions includes a set of symbols as substitutes for a set of numbers in a ground-truth solution for a corresponding example mathematical problem included in the set of example mathematical problems;
generating, via execution of the first machine learning model and based at least on the first prompt, a set of candidate masked solutions to the mathematical problem;
inputting a second prompt that includes (i) the mathematical problem and (ii) at least one masked solution included in the set of candidate masked solutions into a second machine learning model; and
generating, via execution of the second machine learning model based at least on the second prompt, a solution to the mathematical problem.

12. The at least one processor of claim 11, wherein the operations further comprise:
generating, via execution of the second machine learning model based at least on a second mathematical problem and a masked solution to the second mathematical problem, a second solution to the second mathematical problem; and
training a third machine learning model using the mathematical problem, the solution to the mathematical problem, the second mathematical problem, and the second solution to the second mathematical problem.

13. The at least one processor of claim 11, wherein the operations further comprise:
training a third machine learning model using the mathematical problem and the solution to the mathematical problem; and
generating, via execution of the trained third machine learning model, a second solution to a second mathematical problem.

14. The at least one processor of claim 11, wherein the operations further comprise applying a set of filters to the solution.

15. The at least one processor of claim 14, wherein the set of filters is associated with at least one of a correctness of the solution, an ability to execute code included in the solution, a presence of code in the solution, a formatting of the solution, or a number of answers in the solution.

16. The at least one processor of claim 11, wherein the second prompt further includes (i) a second set of example mathematical problems, (ii) a second set of example solutions to the second set of example mathematical problems, and (iii) an instruction to generate the solution to the mathematical problem based at least on the second set of example mathematical problems and the second set of example solutions.

17. The at least one processor of claim 11, wherein the first machine learning model and the second machine learning model are the same machine learning model.

18. The at least one processor of claim 11, wherein the at least one processor is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implementing one or more vision language models (VLMs);
a system implementing one or more multi-modal language models;
a system for generating synthetic data;
a system for performing one or more generative AI operations;
a system incorporating one or more virtual machines (VMs);
a system implemented at least partially in a data center; or
a system implemented at least partially using cloud computing resources.

19. A system comprising:
one or more processing units to generate a solution to a mathematical problem based at least on a masked solution to the mathematical problem, wherein the masked solution is generated using one or more machine learning models based at least on a set of example mathematical problems and a set of example masked solutions to the set of example mathematical problems.

20. The system of claim 19, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implementing one or more vision language models (VLMs);
a system implementing one or more multi-modal language models;
a system for generating synthetic data;
a system for performing one or more generative AI operations;
a system incorporating one or more virtual machines (VMs);
a system implemented at least partially in a data center; or
a system implemented at least partially using cloud computing resources.
